(19) United States
(12) Patent Application Publication
(10) Pub. No.: US 2006/0259758 A1
(43) Pub. Date: Nov. 16, 2006

(54) Instant mode switch for a portable electronic device

(75) Inventors: Hui Deng, San Ramon, CA (US); Kaixuan Mao, Milpitas, CA (US)

Correspondence Address: PATENT LAW GROUP LLP, 2635 NORTH FIRST STREET, SUITE 223, SAN JOSE, CA, 95134, US

(73) Assignee: ArcSoft, Inc.

(21) Appl. No.: 11/130,909

(22) Filed: May 16, 2005

(51) Int. Cl. G06F 1/24

(52) U.S. Cl. 713/100

(57) ABSTRACT

A method for a portable electronic device to operate includes powering on the portable electronic device, displaying a general menu for a user to select one of a plurality of modes for the portable electronic device if an instant mode switch is in a first position, and operating the portable electronic device in a preset mode if the instant mode switch is in a second position.

### FIELD OF INVENTION

This invention relates to portable electronic devices and more specifically to an interface for the portable electronic devices.

### DESCRIPTION OF RELATED ART

Portable electronic devices currently on the market include portable media players, mobile phones, personal data assistants, pocket personal computers, and digital cameras. To use one of these devices, the user must first turn on the device and then navigate through multiple screens and press numerous buttons before the device will provide the desired operations.

### BRIEF DESCRIPTION OF THE DRAWINGS

FIG. 1 is a front view of a portable media player (PMP) in one embodiment of the invention.

FIG. 2 is a side view of the PMP of FIG. 1 in one embodiment of the invention.

FIG. 3 is a block diagram of the components in the PMP of FIG. 1 in one embodiment of the invention.

FIG. 4 illustrates the operation of the instant mode feature in the PMP of FIG. 1 in one embodiment of the invention.

FIG. 5 illustrates the programming of the instant mode feature in the PMP of FIG. 1 in one embodiment of the invention.

Use of the same reference numbers in different figures indicates similar or identical elements.

### SUMMARY

In one embodiment of the invention, a method for a portable electronic device to operate includes powering on the portable electronic device, displaying a general menu for a user to select one of a plurality of modes for the portable electronic device if an instant mode switch is in a first position, and operating the portable electronic device in a preset mode if the instant mode switch is in a second position.

### DETAILED DESCRIPTION

In embodiments of the invention, an “instant mode” feature is provided for a portable electronic device. The portable electronic device may be a portable media player (PMP), a mobile phone, a personal data assistant (PDA), a pocket personal computer (PC), a digital camera, or any other portable electronic device. A user can set an instant mode switch so that when the portable electronic device is turned on, it bypasses the general menu and immediate operates in a preset mode with preset mode settings. For example, a PMP can jump directly into a music player mode and start a play list with a playback mode preset by the user. Thus, the user does not have to navigate multiple screens in the general menu to access a favorite mode of the portable electronic device. Instead, the user jumps directly to his or her favorite mode of operation. Even once the portable device is turned on, the user can still use the instant mode switch to immediately jump to his or her favorite mode on the portable device.

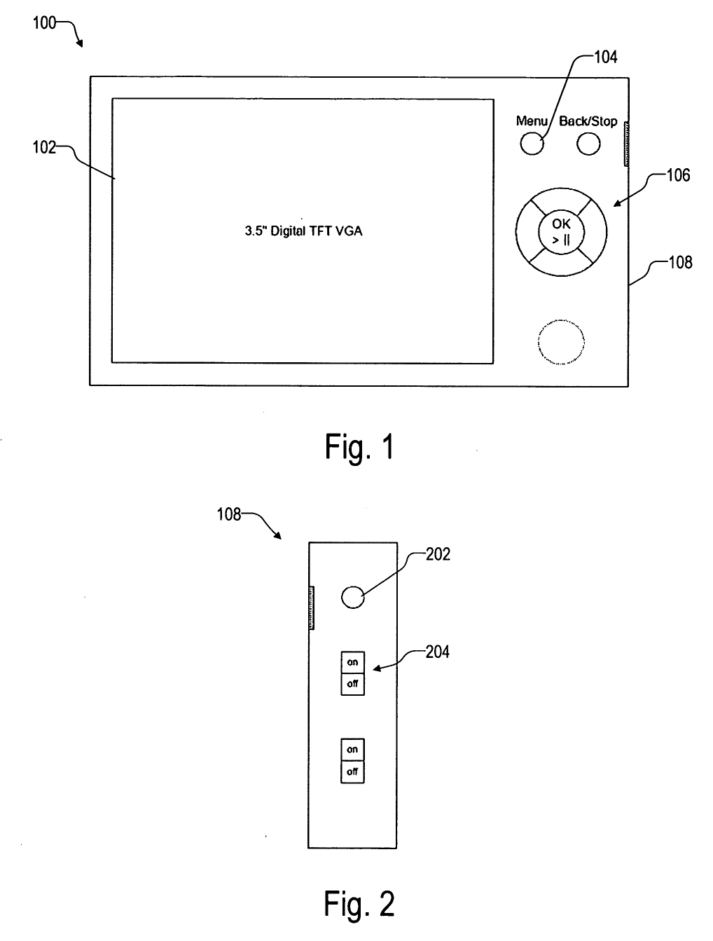

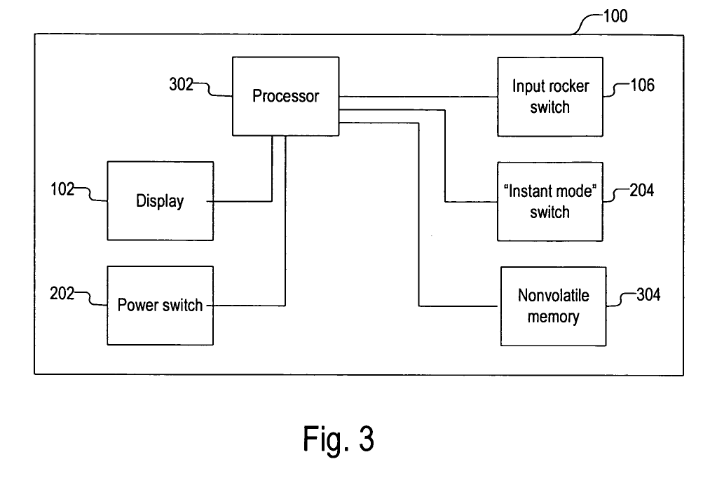

FIGS. 1 and 2 respectively illustrate front and side views of a portable electronic device 100 in one embodiment of the invention. Device 100 may be a PMP that includes hardware and software for playing music and displaying images and videos. The hardware and software may also provide GPS (global positioning system) navigation, gaming, instant messaging, electronic book viewing, web-browsing, calendaring, and other features typically provided by portable electronic devices.

PMP 100 has a screen 102 and an input pad 106 with 5-way rocket buttons. PMP 100 further has a power button 202 and an instant mode slider switch 204 on side 108 of the unit. A user turns on PMP 100 by depressing power button 202 for a predetermined amount of time. Upon powering up, PMP 100 will jump to a preset mode of operation with preset mode settings if the user has set instant mode switch 204 to the “ON” position. Otherwise PMP 100 will proceed with its normal operation if the user has set instant mode switch 204 to the “OFF” position. During the normal operation of PMP 100, the user can set instant mode switch 204 to the “ON” position. In response, PMP 100 will jump to the preset mode with the preset mode settings.

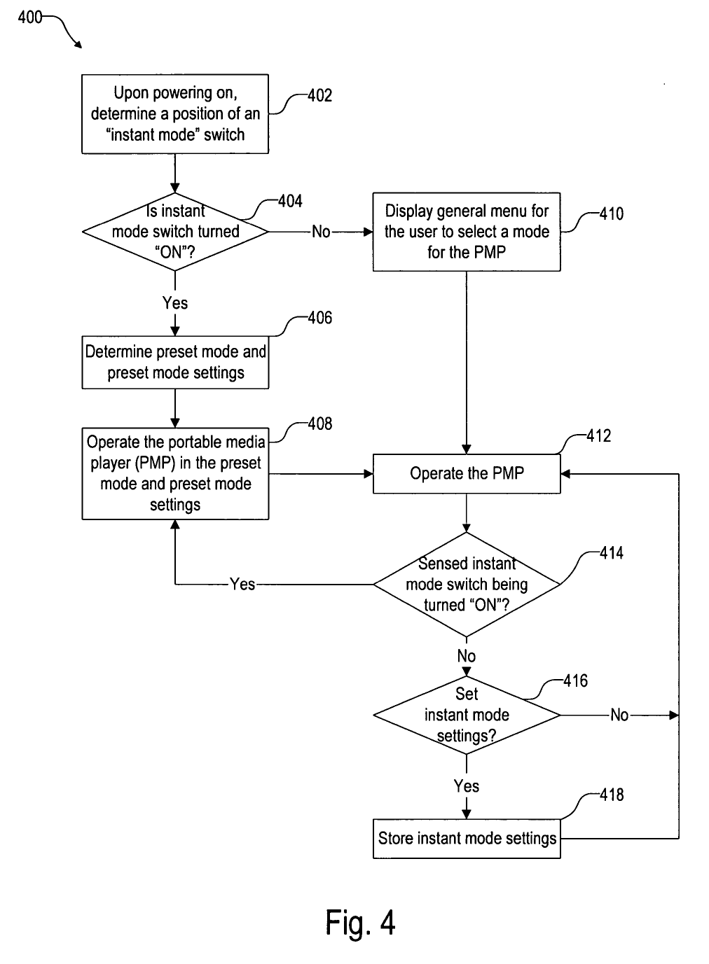

FIG. 3 illustrates a block diagram of PMP 100 in one embodiment of the invention. PMP 100 includes a processing unit 302 connected to display 102, input pad 106, power button 202, instant mode slide switch 204, and a nonvolatile memory 304. Processing unit 302 may be a microprocessor, a DSP (digital signal processor), or a combination thereof. Nonvolatile memory 304 may be a flash memory used to store settings of the PMP 100, including the settings of the instant mode feature. In one embodiment, the instant mode feature is implemented through software executed by processing unit 302.

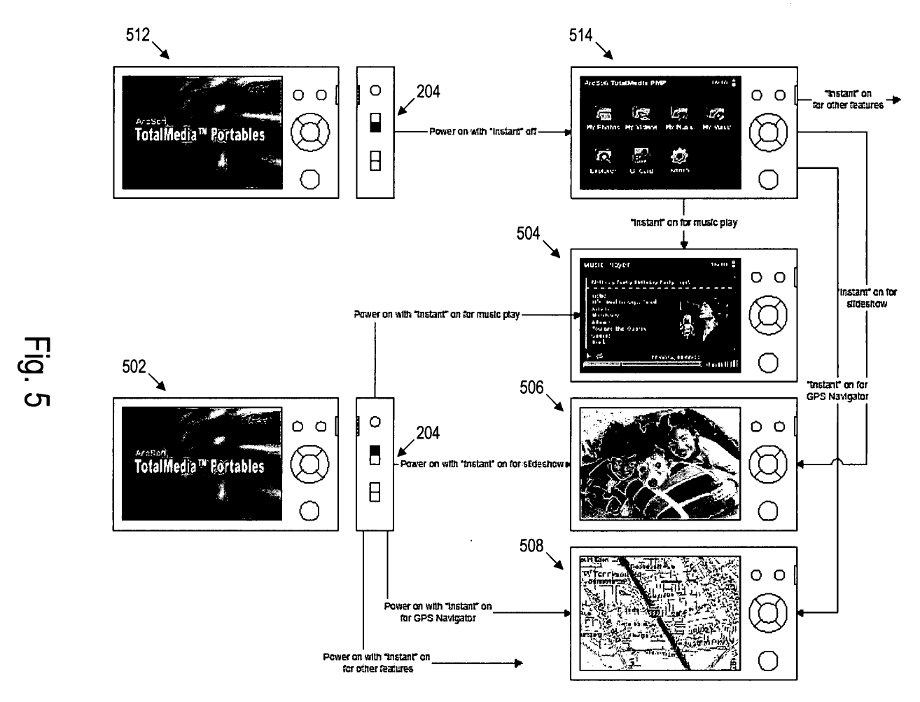

FIG. 4 illustrates a method 400 for implementing the instant mode feature of PMP 100 in one embodiment of the invention. In one embodiment, PMP 100 can operate in the following modes: a music player, an image viewer, a video player, a GPS (global positioning system) navigation device, an instant messenger, a game device, an electronic book viewer, a web browser, and a calendar. PMP 100 allows the user to preset a mode and preset the settings for that mode. For example, the user can select the music player as the preset mode. The user can also preset one of multiple play lists and one of multiple play back modes as settings for the preset mode. The play lists may include the last transferred songs to the player, the last played play list, the last played album, and the last played folder. The play back modes may include shuffle and normal playback.

In step 402, processing unit 302 determines the position of instant mode switch 204 when the user turns on PMP 100.

In step 404, processing unit 304 determines if instant mode switch 204 is in the “ON” position. If so, step 404 is followed by step 406. Otherwise step 404 is followed by step 410.

In step 406, processing unit 302 determines the preset mode and the preset mode settings. In one embodiment, the preset mode and the preset mode settings are stored in nonvolatile memory 304 and processing unit 302 accesses nonvolatile memory 304 to read the preset mode and the preset mode settings. Step 406 is followed by step 408.

In step 408, processing unit 302 operates PMP 100 in the preset mode with the preset mode settings. Step 408 is followed by step 412.

In step 410, processing unit 302 provides a general menu on display 102 for the user to interact with PMP 100. Typically the user navigates through the general menu and subsequent screens to select a mode of operation for PMP 100. The user may also navigate through the general menu and the subsequent screens to setup PMP 100, including setting up the instant mode feature. Step 410 is followed by step 412.

In step 412, processing unit 302 operates PMP 100. Step 412 is followed by step 414.

In step 414, processing unit 302 determines if it has detected that instant mode switch 204 has been turned “ON” during the normal operation of PMP 100. If so, step 414 is followed by step 408 where processing unit 302 operates the PMP is the preset mode with the preset mode settings. Otherwise step 414 is followed by step 416.

In step 416, processing unit 302 determines if the user has selected to setup the settings for the instant mode feature. If so, then step 416 is followed by step 418. Otherwise step 416 is followed by step 412 where processing unit 302 continues with the normal operations of PMP 100.

In step 418, processing unit 302 provides an instant mode menu on display 102 for the user to select the settings of the instant mode feature. After the user selects the settings of the instant mode feature, processing unit 302 saves them in nonvolatile memory 304. Step 418 is followed by step 412 where processing unit 302 continues with the normal operations of PMP 100.

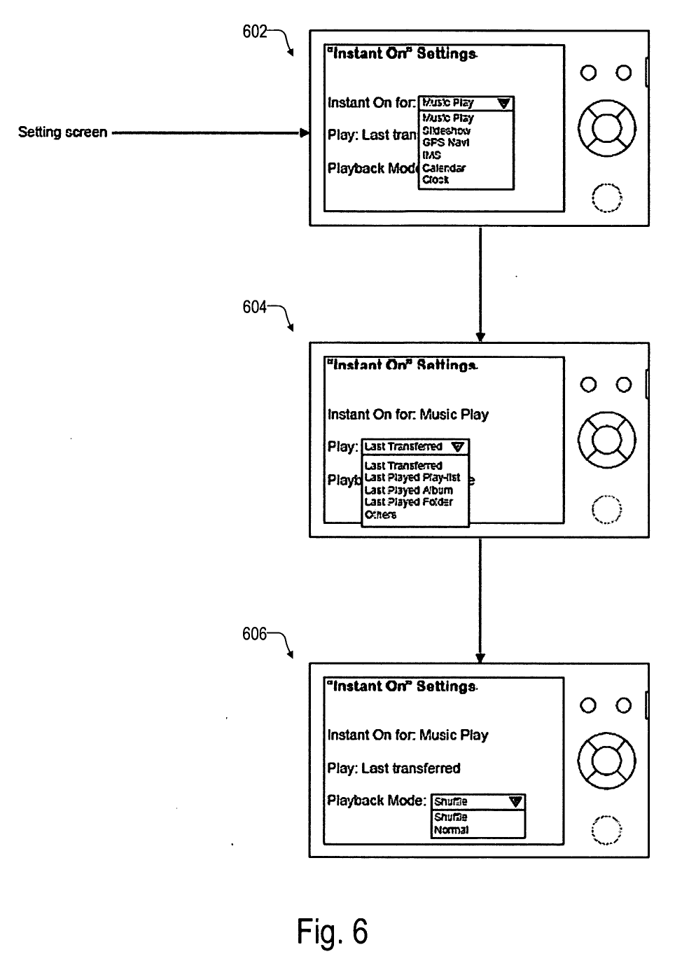

FIG. 5 illustrates the various screens and the flow process of the instant mode feature of PMP 100 in one embodiment of the invention. In screen 502, the user turns on PMP 100 with instant mode switch 204 in the “ON” position. Depending on the saved preset mode, PMP 100 enters into a music player mode shown in screen 504, an image viewer mode shown in screen 506, or a GPS mode shown in screen 508. In each of the modes, PMP 100 will operate with the saved preset mode settings. For example, in the music player mode, PMP 100 may begin to play a selected play list in shuffle play back. In the image viewer mode, PMP 100 may begin a slideshow play back of selected images from a folder. In the GPS mode, PMP 100 may begin to map a route from the current location to a selected location (e.g., home).

In screen 512, the user turns on PMP 100 with instant mode switch 204 in the “OFF” position. In response, PMP 100 provides a general menu shown in screen 514. During normal operations, the user can set instant mode switch 204 to the “ON” position. In response, PMP 100 jumps to the preset mode and operates with the preset mode settings shown in screens 504, 506, and 508.

FIG. 6 illustrates the various screens for setting up the instant mode feature of PMP 100 in one embodiment of the invention. In screen 602, the user presets a mode for the instant mode feature. In screen 604, the user preset a setting for the preset mode. For example, the user selects what music to play back in the music player mode. In screen 606, the user preset another setting for the preset mode. For example, the user selects how to play back the music.

Various other adaptations and combinations of features of the embodiments disclosed are within the scope of the invention. Numerous embodiments are encompassed by the following claims.

What is claimed is:

1. A method for a portable electronic device to operate, comprising:
determining a position of an instant mode switch when powering on the portable electronic device;
if the instant mode switch is in a first position, displaying a general menu for a user to select one of a plurality of modes for the portable electronic device;
if the instant mode switch is in a second position:
determining a preset mode for the portable electronic device;
operating the portable electronic device in the preset mode.

2. The method of claim 1, wherein the portable electronic device is a portable media player, the modes of the portable media player including an audio player, an image viewer, a video player, an instant messenger, a game device, an electronic book viewer, a web-browser, and a calendar.

3. The method of claim 2, wherein if the instant mode switch is in a second position further comprises, further comprising:
determining a setting for the preset mode;
operating the preset mode in accordance with the setting.

4. The method of claim 3, wherein the setting is selected from the group consisting of a play list and a playback mode.

5. The method of claim 3, wherein if the instant mode switch is in a first position, further comprising:
displaying an instant mode switch menu for a user to select the preset mode and the setting for the preset mode.

6. The method of claim 1, wherein the portable electronic device is selected from the group consisting of a portable media player, a mobile phone, a personal data assistant, a pocket personal computer, and a digital camera.

7. A portable electronic device, comprising:
a display;
an instant mode switch for skipping a general menu and operating the portable electronic device into a preset mode;
a nonvolatile memory storing the preset mode;
a processing unit coupled to the instant mode switch, the nonvolatile memory, and the display, wherein:
if the processing unit determines the instant mode switch is in a first position, the processing unit generates on the display the general menu for a user to select one of a plurality of modes for the portable electronic device;
if the processing unit determines the instant mode switch is in a second position:
the processing unit reads the preset mode from the nonvolatile memory;
the processing unit operates the portable electronic in the preset mode.

8. The device of claim 7, wherein the portable electronic device comprises a portable media player, the modes of the portable electronic device including an audio player, an image viewer, and a video player.

9. The device of claim 7, wherein the nonvolatile memory further stores a setting of the preset mode and the processing unit operates the preset mode according to the setting.

10. The device of claim 7, further comprising an input pad for navigating the menu.

11. The device of claim 7, wherein the portable electronic device is selected from the group consisting of a portable media player, a mobile phone, a personal data assistant, a pocket personal computer, and a digital camera.
